(19) United States
(12) Patent Application Publication
(10) Pub. No.: US 2024/0037038 A1
(43) Pub. Date: Feb. 1, 2024

(54) Coherency Domain Cacheline State Tracking

(71) Applicant: Intel Corporation, Santa Clara, CA (US)

(72) Inventors: Nagabhushan Chitlur, Portland, OR (US); Darren Michael Andrus, Apex, NC (US); Kelly Hagen, Cary, NC (US); Randall Bright, Sanford, NC (US)

(21) Appl. No.: 18/478,621

(22) Filed: Sep. 29, 2023

(51) Int. Cl. G06F 12/0831; G06F 12/0817; G06F 13/42

(52) U.S. Cl. CPC G06F 12/0835; G06F 12/0817; G06F 13/4234

(57) ABSTRACT

Circuitry, systems, and methods are provided for an integrated circuit including an acceleration function unit to provide hardware acceleration for a host device. The integrated circuit may also include interface circuitry including a cache coherency bridge/agent including a device cache to resolve coherency with a host cache of the host device. The interface circuitry may also include cacheline state tracker circuitry to track states of cachelines of the device cache and the host cache. The cacheline state tracker circuitry provides insights to expected state changes based on states of the cachelines of the device cache, the host cache, and a type of operation performed.

### BACKGROUND

The present disclosure relates to resource-efficient circuitry of an integrated circuit that can provide visibility into states of a cacheline.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Memory is increasingly becoming the single most expensive component in datacenters and in electronic devices driving up the overall total cost of ownership (TCO). More efficient usage of memory via memory pooling and memory tiering is seen as the most promising path to optimize memory usage. With the availability of compute express link (CXL) and/or other device/CPU-to-memory standards, there is a foundational shift in the datacenter architecture with respect to disaggregated memory tiering architectures as a means of reducing the TCO. Memory tiering architectures may include pooled memory, heterogeneous memory tiers, and/or network connected memory tiers all of which enable memory to be shared by multiple nodes to drive a better TCO. Intelligent memory controllers that manage the memory tiers are a key component of this architecture. However, tiered memory controllers residing outside of a memory coherency domain may not have direct access to coherency information from the coherent domain making such deployments less practical and/or impossible. One mechanism to address this coherency domain problem may be to use operating system (OS)/virtual memory manager (VMM)/hypervisor techniques to track page tables to log which pages are accessed. However, such deployments may be inefficient when only a small number (e.g., a single) of cachelines of a page is modified since the whole page is marked as dirty. For instance, the page size may be relatively large (e.g., 4 KB) and need to be refreshed when only a relatively small cacheline (e.g., 64 B) of the page is modified. This coarse-grained, page-based tracking may be quite inefficient.

### BRIEF DESCRIPTION OF THE DRAWINGS

Various aspects of this disclosure may be better understood upon reading the following detailed description and upon reference to the drawings in which:

FIG. 1 is a block diagram of a system including a first device and a second device coupled

together with a link, in accordance with an embodiment of the present disclosure;

FIG. 2 is a block diagram of a system including the first device and the second device, where the second device includes a coherency domain cacheline state tracker (CLST), in accordance with an embodiment of the present disclosure;

FIG. 3 is a block diagram of an interaction between a CLST interface in a respective cache coherency bridge/agent with a respective CLST processing slice, in accordance with an embodiment of the present disclosure; and

FIG. 4 is a data processing system that may incorporate the second device, in accordance

with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As previously noted, an intelligent memory controller outside of a memory coherency domain could use access to coherency information from the coherency domain to provide efficient memory usage. For instance, such intelligent memory controllers may use telemetry into page access patterns and changes in coherency states of cachelines of a processor (e.g., CPU). A coherency domain cacheline state tracker (CLST) may be used to track such information to enable intelligent tiered memory controllers and/or near-memory accelerators outside of a coherency domain to monitor cacheline state changes at the cacheline granularity so actions such as page migration can be performed efficiently. As discussed, the CLST enables monitoring of modified, exclusive, shared, and invalid (MESI) state changes for all the cacheline mapped to a memory controlled/owned by the device implementing the CLST. For instance, the device may be a compute express link (CXL) type 2 device or other device that includes general purpose accelerators (e.g., GPUs, ASICs, FPGAs, and the like) to function with graphics double-data rate (GDDR), high bandwidth memory (HBM), or other types of local memory. As such, the CXL type 2 devices enable the implementation of a cache that a host can see without using direct memory access (DMA) operations. Instead, the memory can be exposed to the host OS like it is just standard memory even if some of the memory may be kept private from the processor. The interface through this device implementing the CLST provides real-time (or near real-time) information of any state changes enabling the device to monitor read and write access patterns along with MESI state changes for caches in the processor and the device. Furthermore, the interface enables MESI state change tracking at a cacheline granularity. Additionally, address ranges (e.g., for read or write addresses) reflected on the CLST may be monitored for such addresses. If an accelerator requests a coherency state change to enable a benefit, the accelerator may have visibility into whether the state (and related benefit) has occurred using the CLST. If a subsequent state change disables the benefit, the CLST ensures that the accelerator is informed. This enables the accelerator to re-enable the benefit if the benefit is still desirable.

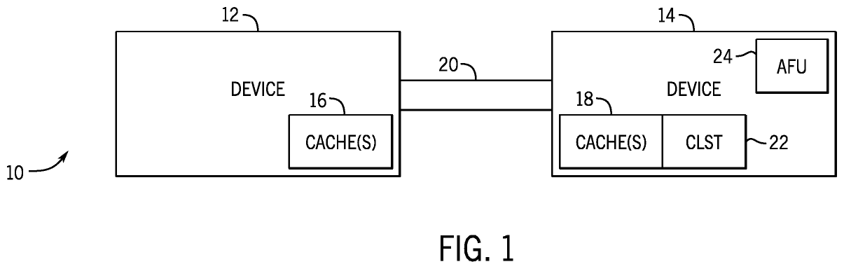

With the foregoing in mind, FIG. 1 illustrates a block diagram of a system 10 that includes a first device 12 and a second device 14. The first device 12 and the second device 14 may include respective caches 16 and 18. The first device 12 and the second device 14 may be coupled together using a link 20. The link 20 may be any link type suitable for connecting the first device 12 with the second device 14. For instance, the link type may be a peripheral component interconnect express (PCIe) link or other suitable link type. Additionally or alternatively, the link 20 may utilize one or more protocols built on top of the link type. For instance, the link type may include a type that includes at least one physical layer (PHY) technology. These one or more protocols may include one or more standards to be used via the link type. For instance, the one or more protocols may include compute express link (CXL) or other suitable connection type that may be used over the link 20.

In many link types, the first device 12 may not have visibility into the cache(s) 18, MESI states of the cache(s) 18, and/or operations/upcoming operations to be performed by the second device 14. Similarly, the second device 14 may not have visibility into the cache(s) 16, MESI states of the cache(s) 16, and/or operations/upcoming operations to be performed by the first device 12. Additionally or alternatively, as previously noted, an OS/VMM/hypervisor may track whether pages are dirty across the link. However, this mechanism includes a lack of granularity/predictability that may cause inefficient use of coherency mechanisms between the first device 12 and the second device 14 by cleaning a whole page (e.g., 4 kB) of the cache(s) 16 or 18 when it may be only a single cacheline (e.g., 64 B) that needs to be cleaned/refreshed. To address this coherency efficiency problem, a cacheline state tracker (CLST) 22 may be included in at least one device (e.g., the second device 14). As previously noted, the CLST 22 provides coherency state change information to circuitry 24 that may be outside of the coherency domain of the first device 12. For instance, the circuitry 24 may be an acceleration function unit (AFU) that uses a programmable fabric to assist the first device 12 (e.g., a processor) in completing a function by acting as an accelerator for the first device 12. Additionally or alternatively, the circuitry 24 may include any other suitable circuitry, such as an application-specific integrated circuit (ASIC), a co-processor (e.g., graphics processing unit (GPU)), field-programmable gate array (FPGA), and/or other circuitry. This allows the second device 14 (e.g., AFU) to build custom directories or custom tracking logic enabling the second device 14 to act as an intelligent memory controller. The second device 14 is able to ascertain the state of a cacheline in both the cache 16 and the cache 18 and is thereby able to take actions based on the state of the cachelines of both caches 16 and 18.

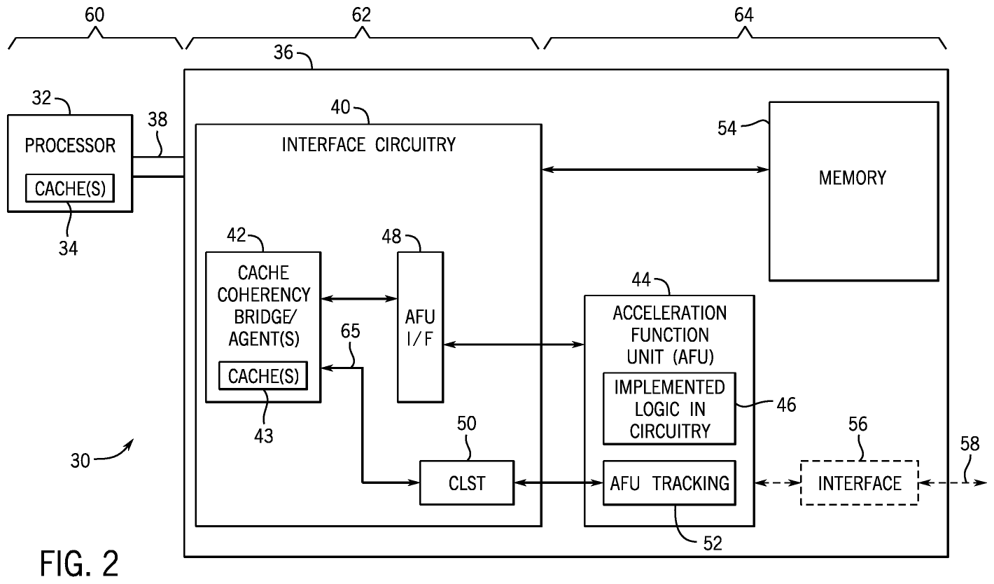

FIG. 2 is a block diagram of a system 30. The system 30 may be a specific embodiment of the system 10. However, other embodiments may also be consistent with the teachings herein. As illustrated in FIG. 2, the system 30 includes a processor 32 that has a cache 34. The processor 32 is coupled to a device 36 via a link 38. For instance, the processor 32 may be an embodiment of the first device 12 of the system 10, the cache 34 may be an embodiment of the cache 16 of the system 10. The device 36 may be an embodiment of the second device 16 of the system 10. For instance, the device 36 may be an FPGA. Additionally or alternatively, the device 36 may be a device that integrates an application-specific integrated circuit (ASIC) with an FPGA and/or other programmable logic devices, may be a dedicated ASIC device without an integrated FPGA, may include any suitable accelerator devices (GPUs), and/or any other suitable device that may couple to the processor 32 via the link 38 and that may benefit from access to the cache(s) 34. The link 38 may be any embodiment of the link 20 of FIG. 1.

The device 36 also includes interface circuitry 40. For instance, the interface circuitry 40 may include an ASIC and/or other circuitry to at least partially implement an interface between the device 36 and the processor 32. For instance, the interface circuitry 40 may be used to implement CXL protocol-based communications using one or more cache coherency bridge/agent(s) 42. The cache coherency bridge/agent(s) 42 is an agent on the device 36 that is responsible for resolving coherency with respect to device caches. Specifically, the cache coherency bridge/agent(s) 42 may include their own cache(s) 43 that may be maintained to be coherent with the cache(s) 34. In some embodiments, there may be multiple interface circuitries 40 per device 36. Additionally or alternatively, there may be multiple devices 36 included in a single system.

As previously noted, the device 36 includes an acceleration function unit (AFU) 44. For instance, the AFU 44 may be included as an accelerator (e.g., FPGA, ASIC, GPU, programmable logic devices, etc.) that uses implemented logic in circuitry 46 to perform a function to accelerate a function from the processor 32. As previously noted, the AFU 44 may be an accelerator that is incorporated in the device 36 based on the device 36 being a CXL type 2 device. The AFU 44 includes implemented logic in circuitry 46. The implemented logic in circuitry 46 may include logic implemented in a programmable fabric and/or hardware circuitry. The implemented logic in circuitry 46 may be used to issue requests on the interface circuitry 40.

As previously discussed, the device 36 also includes a cacheline state tracker (CLST) 50. In some embodiments, there may be multiple cache coherency bridge/agent(s) 42 that each couple to the same CLST 50. In other words, each cache coherency bridge/agent(s) 42 may be coupled to a slice of the CLST 50. Additionally or alternatively, there may be multiple cache coherency bridge/agent(s) 42 that couple to their own CLSTs 50.

The device 36 may also include AFU tracking circuitry 52 that interfaces with the CLST 50 using an appropriate interface type, such as AXI4 ST or other interface to provide updates to the AFU 44 and/or implemented logic in circuitry 46. The AFU tracking circuitry 52 may refer to custom directories that keep track of the state of the cacheline to decide which page is to be migrated and when the page should be migrated. For instance, this directory may be proprietary and can be built to serve the policies associated with the cacheline tracking for a customer, user, profile, or the like. The updates may indicate changes in the cache(s) 34, such as changes in host/HDM addresses. The AFU tracking circuitry 52 may be implemented using an ASIC and/or implemented using a programmable fabric.

The device 36 may also include memory 54 that may be used by the device 36 and/or the host (e.g., processor 32). For instance, if the device 36 is a CXL type 2 device, the memory 54 may be host-management device memory (HDM). In some embodiments, the device 36 may include another interface 56 to connect to other devices/networks. For example, the interface 56 may be a high-speed serial interface subsystem that couples the device 36 to a link 58 to a network.

As may be appreciated, the processor 32 may be in a host domain 60 that has inherent access to the cache(s) 34. The interface circuitry 40 is in a coherent domain 62 that maintains coherency with the cache(s) 34. For instance, the cache(s) 34 may be coherent with the cache(s) 43 using an appropriate protocol (CXL) over the link 38. The cache(s) 43 may have a MESI state and use a protocol (e.g., CXL) to bring other information that the host needs/requests to provide insight. For instance, if seeking ownership, this other information may make clear whether ownership may be able to be transferred properly. A non-coherent domain 64 may typically not have access or visibility into states of one or more caches (e.g., cache(s) 34). However, using the CLST 50 and the AFU tracking circuitry 52, portions in the non-coherent domain 64 may be able to have visibility into the states of the one or more caches.

AFU requests can cause a state change in the cache(s) 34 and/or caches of the device 36. Host cache (CXL.$) snoops and host memory (CXL.M) requests can cause a state change in device 36 caches and can imply state changes in host caches (e.g., cache(s) 34). If any of these requests cause a state change, an update will be issued on the CLST 50 from the cache coherency bridge/agent 42. The CLST 50 updates may provide the cacheline address(es), the cache original and/or final states of caches of the device 36, the original and/or final states of the cache(s) 34, and the what (e.g., the source) that causes the state change.

Each cache coherency bridge/agent(s) 42 provides a connection 65 between a dedicated port of the respective cache coherency bridge/agent(s) 42 to a respective port of the CLST 50. In some embodiments, each port has one interface for device (HDM) address updates and one interface for host address updates. In some embodiments, the connection 65 can issue one CLST update per clock cycle.

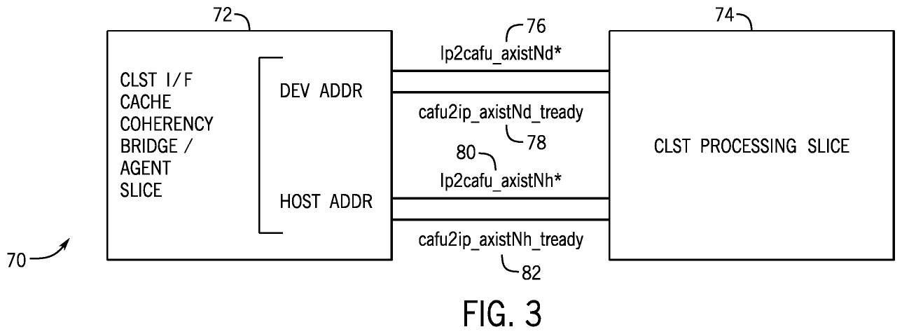

If the CLST 50 streams out information that the AFU 44 cannot absorb (e.g., due to full buffers/registers), the AFU 44 may notify the CLST 50 (or fail to confirm receipt of the streamed information). The CLST 50 may send back pressure to the cache coherency bridge/agent(s) 42 and/or host via the link 38 to keep from dropping transmitted information. For instance, connections 65/interfaces may provide backpressure input to control when new CLST updates are issued from the respective cache coherency bridge/agent(s) 42. For instance, FIG. 3 shows a block diagram of an interaction 70 between a CLST interface 72 in a respective cache coherency bridge/agent(s) 42 with a respective CLST processing slice 74 that corresponds with the CLST interface 72 in the CLST 50. As illustrated, the CLST interface 72 sends a first signal 76 (Ip2cafu_axistNd*) to the CLST processing slice 74. The first signal 76 may be any available signals for the CLST interface 72. For instance, the first signal 76 may include a streaming data valid indicator that indicates validity of streaming data for a cache of the device 36, a streaming data indicator, a streaming data byte indicator, a streaming data boundary indicator, a streaming data identifier, streaming data routing information, streaming data user information, and/or any other suitable signal type for use over the CLST interface 72. The various signals may be sent together in a packet and/or separately and may have appropriate bit lengths. For instance, the validity indicator may be a flag while the streaming data indicator may have a number (e.g., 8, 16, 32, 72, etc.) of bits. Likewise, a single indicator may include a variety of information. For instance, the streaming data indicator may include a first number of bits (e.g., 52) indicating a cacheline address for the device 36 and/or the processor 32, a second number (e.g., 4) of bits indicating an original state of the cache of the device 36, a third number (e.g., 4) of bits indicating a final state of the cache of the device 36 after the change, a fourth number (e.g., 4) of bits indicating an original state of the cache of the processor 32, a fifth number (e.g., 4) of bits indicating a final state of the cache of the processor 32, a sixth number (e.g., 1) of bits indicating a source of the state change (e.g., processor 32 or the device 36), and/or other bits carrying information about the state change.

The CLST processing slice 74 responds with a first response signal 78 (cafu2ip_axistNd_tready) or ready signal that indicates whether the CLST processing slice 74 is ready to accept streaming data. If the CLST interface 72 does not receive the ready signal, the CLST interface 72 via the link 38 may hold data in buffers and/or indicate to the processor 32 to delay sending more data until the CLST processing slice 74 is ready for more streaming information. At that point, any buffered data may begin issuing from the CLST interface 72 to the CLST processing slice 74. Additionally or alternatively, the CLST processing slice 74 may send a not ready signal (in place of or in addition to the cafu2ip_axistNd_tready signal) when the CLST processing slice 74 is not ready to process more streaming data to cause the CLST interface 72 to hold data until the CLST processing slice 74 is ready.

As illustrated, the CLST interface 72 sends a second signal 80 (Ip2cafu_axistNh*) to the CLST processing slice 74. The second signal 80 may be any available signals for the CLST interface 72. For instance, the first signal 76 may include a streaming data valid indicator that indicates validity of streaming data for a cache of the host (processor 32), a streaming data indicator, a streaming data byte indicator, a streaming data boundary indicator, a streaming data identifier, streaming data routing information, streaming data user information, and/or any other suitable signal type for use over the CLST interface 72. The various signals may be sent together in a packet and/or separately and may have appropriate bit lengths. For instance, the validity indicator may be a flag while the streaming data indicator may have a number (e.g., 8, 16, 32, 72, etc.) of bits. Likewise, a single indicator may include a variety of information. For instance, the streaming data indicator may include a first number of bits (e.g., 52) indicating a cacheline address for the device 36 and/or the processor 32, a second number (e.g., 4) of bits indicating an original state of the cache of the processor 32, a third number (e.g., 4) of bits indicating a final state of the cache of the processor 32 after the change, a fourth number (e.g., 4) of bits indicating an original state of the cache of the processor 32, a fifth number (e.g., 4) of bits indicating a final state of the cache of the processor 32, a sixth number (e.g., 1) of bits indicating a source of the state change (e.g., processor 32 or the device 36), and/or other bits carrying information about the state change.

The CLST processing slice 74 responds with a second response signal 82 (cafu2ip_axistNh_tready) or ready signal that indicates whether it is ready to accept streaming data. If the CLST interface 72 does not receive the ready signal, the CLST interface 72 via the link 38 may indicate the processor 32 to delay sending more data until the CLST processing slice 74 is ready for more streaming information. Additionally or alternatively, the CLST processing slice 74 may send a not ready signal (in place of or in addition to the cafu2ip_axistNh_tready signal) when the CLST processing slice 74 is not ready to process more streaming data.

The following Table 1 describes potential state changes that the CLST 50 may report based on a corresponding change source operation causing the state transitions. Table 1 includes an “M” for modified states indicating that the cacheline is “dirty” or has changed since being last cached, an “E” for exclusive states indicating sole possession of the cacheline, an “S” for a shared state indicating that it is stored in at least two caches, and an “I” for invalid states indicating that the cacheline is invalid/unused. Because it may not be possible or may be unnecessary to know the host cache state, the Table 1 includes “Unknown” for such conditions. In some cases, the host cache state may be one of two states, such as either invalid or shared (“I/S”) or invalid or modified (“I/M”) or exclusive or modified (“E/M”). Table 1 includes an “I/S”, “E/M”, and “I/M” and similar tags to show these states. In some embodiments of these dual possible states, the host (processor 32) may decide whether to hold or drop the cacheline. Moreover, Table 1 is an illustrative and non-exclusionary list of state changes tracked in the CLST 50 based on original/final states the operation(s) that causes those changes.

TABLE 1
Example CLST state changes

| Device | Device | Host | Host | |
|---|---|---|---|---|
| Original | Device | Original | Final | State Change Source |
| State | State | State | State | and Operation |
| I | S | Unknown | I/S | Device read |
| I | E | Unknown | I | Device read |
| I | M | M | I | Device read |
| | | I | I | Device write |
| S | E | I/S | I | Device read |
| S | M | I | I | Device write |
| E | M | I | I | Device write |
| M | E | — | — | None |
| M | S | I | S | Host snoop, reads device data |
| M | I | I | I | Device read |
| | | | | Host read, snoop, write |
| | | I | E | Host read or snoop |
| | | I | M | Host snoop |
| E | S | I | S | Host snoop, host read |
| E | I | I | I | Device read |
| | | | | Host read, snoop, write |
| | | I | E | Host snoop, host read |
| S | I | I/S | I/S | Device read |
| | | | | Host read, snoop |
| | | I/S | I/M | Device write |
| | | I/S | I | Host read, snoop, write |
| | | I/S | E | Host snoop, read |
| I | I | I | S | Host read, snoop, write |
| | | I/S | E | Host read, snoop |
| | | Unknown | M | Host-attached memory address: if device cache is |
| | | | | invalid host can change to M without snooping device |
| | | | | causing device to be unable to see host cache change |
| I | I | E/M | E | Host write |
| | | | | If host cleans host cache, device will not see host |
| | | | | cache change. |
| | | E/M | S | Host writeIf host downgrades host cache, device will |
| | | | | not see host cache change. |
| | | M | I | Host write. |
| | | | | If host cleans and invalidates host cache, device will |
| | | | | not see host cache change. |
| | | E | I | If host invalidates host cache, device will not see host |
| | | | | cache change. |
| | | I/S | I | Host write, snoop If host invalidates host cache, device |
| | | | | will not see host cache change. |
| S | S | I | S | Host read, snoop |

As used in the Table 1, the use of a “,” between operations may indicate both operations are performed or only one operation is performed. Additionally, the entries of Table 1 may include additional differentiating factors for the different operations, such as different meta field values indicating whether the host is to have an exclusive copy, have a shared copy, have a non-cacheable but current value (NO-OP) with or without invalidation, have ownership of the cacheline without the data, request that the device invalidate its cache, have its cache dropped from E or S states in an I state, and/or other information that may be useful in the CLST 50 determining which final states are to result from the operation.

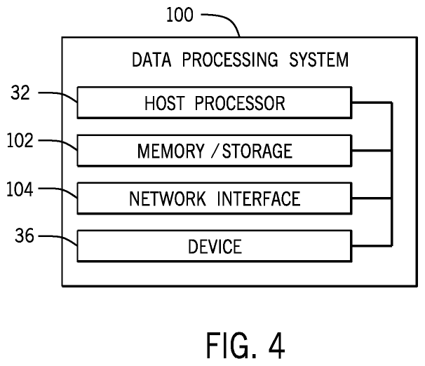

The device 36 may be a component included in a data processing system, such as a data processing system 100, shown in FIG. 4. The data processing system 100 may include the device 36, a host processor (processor 32), memory and/or storage circuitry 102, and a network interface 104. The data processing system 100 may include more or fewer components (e.g., electronic display, user interface structures, application specific integrated circuits (ASICs)). The processor 32 may include any of the foregoing processors that may manage a data processing request for the data processing system 100 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 102 may include random access memory (RAM), read-only memory (ROM), one or more hard drives, flash memory, or the like. The memory and/or storage circuitry 102 may hold data to be processed by the data processing system 100. In some cases, the memory and/or storage circuitry 102 may also store configuration programs (e.g., bitstreams, mapping function) for programming the device 36. The network interface 104 may allow the data processing system 100 to communicate with other electronic devices. The data processing system 100 may include several different packages or may be contained within a single package on a single package substrate. For example, components of the data processing system 100 may be located on several different packages at one location (e.g., a data center) or multiple locations. For instance, components of the data processing system 100 may be located in separate geographic locations or areas, such as cities, states, or countries.

The data processing system 100 may be part of a data center that processes a variety of different requests. For instance, the data processing system 100 may receive a data processing request via the network interface 104 to perform encryption, decryption, machine learning, video processing, voice recognition, image recognition, data compression, database search ranking, bioinformatics, network security pattern identification, spatial navigation, digital signal processing, or other specialized tasks.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. An integrated circuit device including an acceleration function unit to provide hardware acceleration for a host device, and interface circuitry including a cache coherency bridge/agent including a device cache to resolve coherency with a host cache of the host device. The interface circuitry also includes cacheline state tracker circuitry to track states of cachelines of the device cache and the host cache, where the cacheline state tracker circuitry is to provide insights to expected state changes based on states of the cachelines of the device cache, the host cache, and a type of operation performed.

EXAMPLE EMBODIMENT 2. The integrated circuit device of example embodiment 1, where the type of operation includes a memory operation performed by the host device.

EXAMPLE EMBODIMENT 3. The integrated circuit device of example embodiment 1, where the type of operation includes a memory operation performed by the integrated circuit device.

EXAMPLE EMBODIMENT 4. The integrated circuit device of example embodiment 1, where the type of operation includes a state change of the host cache.

EXAMPLE EMBODIMENT 5. The integrated circuit device of example embodiment 1, where tracking the states of the cachelines includes tracking an original state of the device cache and tracking a final state of the device cache.

EXAMPLE EMBODIMENT 6. The integrated circuit device of example embodiment 5, where tracking the states of the cachelines includes tracking an original state of the host cache and tracking a final state of the host cache using compute express link cache operations.

EXAMPLE EMBODIMENT 7. The integrated circuit device of example embodiment 1, where the cacheline state tracker circuitry is to track states of the device cache and the host cache on a cacheline-by-cacheline granularity.

EXAMPLE EMBODIMENT 8. The integrated circuit device of example embodiment 1, where the acceleration function unit includes acceleration function unit tracking implemented in the programmable fabric of the programmable logic device

EXAMPLE EMBODIMENT 9. The integrated circuit device of example embodiment 8, where the acceleration function unit includes acceleration function unit tracking implemented in the programmable fabric of the programmable logic device.

EXAMPLE EMBODIMENT 10. The integrated circuit device of example embodiment 9, where the acceleration function unit tracking is to interface with the cacheline state tracker circuitry and includes custom directories that track the state of the cachelines to decide which page is to be migrated and when the page is to be migrated.

EXAMPLE EMBODIMENT 11. The integrated circuit device of example embodiment 1, including memory.

EXAMPLE EMBODIMENT 12. The integrated circuit device of example embodiment 11, including a compute express link type 2 device that exposes the memory to the host device using compute express link memory operations.

EXAMPLE EMBODIMENT 13. An integrated circuit device including a first portion in a first coherency domain, including an acceleration function unit to provide hardware acceleration for a host device and a memory to store data. The integrated circuit device also includes a second portion in a second coherency domain that is coherent with the host device. The second portion includes interface circuitry including a plurality of cache coherency agents including a plurality of device caches to resolve coherency with one or more host caches of the host device and a plurality of cacheline state tracker circuitries to track states of cachelines of the plurality of device caches and the one or more host caches, where the plurality of cacheline state tracker circuitries is to provide predictions of final states based on original states of the cachelines of the plurality of device caches, the one or more host caches, and a type of operation being performed.

EXAMPLE EMBODIMENT 14. The integrated circuit device of example embodiment 13, where the interface circuitry includes a compute express link interface to enable the first coherency domain to have visibility into the states of the plurality of device caches or the one or more host caches.

EXAMPLE EMBODIMENT 15. The integrated circuit device of example embodiment 13, where the first portion includes a network interface to enable the acceleration function unit to send or receive data via a network.

EXAMPLE EMBODIMENT 16. The integrated circuit device of example embodiment 14, where each of the plurality of cacheline state tracker circuitries are configured to backpressure a corresponding cache coherency agent of the plurality of cache coherency agents to control when updates are made to each of the plurality of cacheline state tracker circuitries.

EXAMPLE EMBODIMENT 17. The integrated circuit device of example embodiment 16, where backpressure includes a ready or unready signal indicating that the respective cacheline state tracker circuitry is not ready to receive additional data in response to a previous signal.

EXAMPLE EMBODIMENT 18. The integrated circuit device of example embodiment 17, where the previous signal includes a validity of streaming data signal, a streaming data indicator signal, a streaming data byte indicator signal, a streaming data boundary indicator signal, a streaming data identifier signal, a streaming data routing information signal, or a streaming data user information signal.

EXAMPLE EMBODIMENT 19. A programmable logic device including interface circuitry that includes a cache coherency bridge including a device cache that the cache coherency bridge is to maintain coherency with a host cache of a host device using a communication protocol with the host device over a link and a cacheline state tracker to track original and final states of the host cache and the device cache based on an operation performed by the host device or the programmable logic device. The programmable logic device also includes an acceleration function unit to provide a hardware acceleration function for the host device. The acceleration function unit includes logic circuitry to implement the hardware acceleration function in a programmable fabric of the acceleration function unit and acceleration function unit tracking implemented in the programmable fabric of the programmable logic device and to interface with the cacheline state tracker to determine whether a page of a cache is to be migrated. The programmable logic device also includes a memory that is exposed to the host device as host-managed device memory to be used in the hardware acceleration function.

EXAMPLE EMBODIMENT 20. The programmable logic device of example embodiment 19, where the communication protocol includes a compute express link protocol that exposes the memory to the host device using compute express link memory operations.

What is claimed is:

1. An integrated circuit device, comprising:
an acceleration function unit to provide hardware acceleration for a host device;
interface circuitry, comprising:
a cache coherency bridge/agent comprising a device cache to resolve coherency with a host cache of the host device; and
cacheline state tracker circuitry to track states of cachelines of the device cache and the host cache, wherein the cacheline state tracker circuitry is to provide insights to expected state changes based on states of the cachelines of the device cache, the host cache, and a type of operation performed.

2. The integrated circuit device of claim 1, wherein the type of operation comprises a memory operation performed by the host device.

3. The integrated circuit device of claim 1, wherein the type of operation comprises a memory operation performed by the integrated circuit device.

4. The integrated circuit device of claim 1, wherein the type of operation comprises a state change of the host cache.

5. The integrated circuit device of claim 1, wherein tracking the states of the cachelines comprises tracking an original state of the device cache and tracking a final state of the device cache.

6. The integrated circuit device of claim 5, wherein tracking the states of the cachelines comprises tracking an original state of the host cache and tracking a final state of the host cache using compute express link cache operations.

7. The integrated circuit device of claim 1, wherein the cacheline state tracker circuitry is to track states of the device cache and the host cache on a cacheline-by-cacheline granularity.

8. The integrated circuit device of claim 1, wherein the acceleration function unit comprises a programmable logic device having a programmable fabric.

9. The integrated circuit device of claim 8, wherein the acceleration function unit comprises acceleration function unit tracking implemented in the programmable fabric of the programmable logic device.

10. The integrated circuit device of claim 9, wherein the acceleration function unit tracking is to interface with the cacheline state tracker circuitry and includes custom directories that track the state of the cachelines to decide which page is to be migrated and when the page is to be migrated.

11. The integrated circuit device of claim 1, comprising memory.

12. The integrated circuit device of claim 11, comprising a compute express link type 2 device that exposes the memory to the host device using compute express link memory operations.

13. An integrated circuit device, comprising:
a first portion in a first coherency domain, comprising:
an acceleration function unit to provide hardware acceleration for a host device; and
a memory to store data; and
a second portion in a second coherency domain that is coherent with the host device, comprising:
interface circuitry, comprising:
a plurality of cache coherency agents comprising a plurality of device caches to resolve coherency with one or more host caches of the host device; and
a plurality of cacheline state tracker circuitries to track states of cachelines of the plurality of device caches and the one or more host caches, wherein the plurality of cacheline state tracker circuitries is to provide predictions of final states based on original states of the cachelines of the plurality of device caches, the one or more host caches, and a type of operation being performed.

14. The integrated circuit device of claim 13, wherein the interface circuitry comprises a compute express link interface to enable the first coherency domain to have visibility into the states of the plurality of device caches or the one or more host caches.

15. The integrated circuit device of claim 13, wherein the first portion comprises a network interface to enable the acceleration function unit to send or receive data via a network.

16. The integrated circuit device of claim 14, wherein each of the plurality of cacheline state tracker circuitries are configured to backpressure a corresponding cache coherency agent of the plurality of cache coherency agents to control when updates are made to each of the plurality of cacheline state tracker circuitries.

17. The integrated circuit device of claim 16, wherein backpressure comprises a ready or unready signal indicating that the respective cacheline state tracker circuitry is not ready to receive additional data in response to a previous signal.

18. The integrated circuit device of claim 17, wherein the previous signal comprises a validity of streaming data signal, a streaming data indicator signal, a streaming data byte indicator signal, a streaming data boundary indicator signal, a streaming data identifier signal, a streaming data routing information signal, or a streaming data user information signal.

19. A programmable logic device, comprising:
interface circuitry, comprising:
a cache coherency bridge comprising a device cache that the cache coherency bridge is to maintain coherency with a host cache of a host device using a communication protocol with the host device over a link; and
a cacheline state tracker to track original and final states of the host cache and the device cache based on an operation performed by the host device or the programmable logic device;
an acceleration function unit to provide a hardware acceleration function for the host device and comprising:
logic circuitry to implement the hardware acceleration function in a programmable fabric of the acceleration function unit; and
acceleration function unit tracking implemented in the programmable fabric of the programmable logic device and to interface with the cacheline state tracker to determine whether a page of a cache is to be migrated; and
a memory that is exposed to the host device as host-managed device memory to be used in the hardware acceleration function.

20. The programmable logic device of claim 19, wherein the communication protocol comprises a compute express link protocol that exposes the memory to the host device using compute express link memory operations.
